(19) United States
(12) Patent Application Publication
(10) Pub. No.: US 2026/0152674 A1
(43) Pub. Date: Jun. 4, 2026

(54) Adhesives for Wet or Dry Adhesion

(71) Applicant: Solventum Intellectual Properties Company, Maplewood, MN (US)

(72) Inventors: Adam R. Wohl, Mahtomedi, MN (US); Yasuhiro Kinoshita, Tokyo (JP); Don A. Rizzardi, Woodbury, MN (US); Mary L. West, Eagan, MN (US); Miriam E. Paquet, Woodbury, MN (US); Kejian Chen, Woodbury, MN (US); Vinod P. Menon, Woodbury, MN (US); Ying Zhang, Woodbury, MN (US)

(21) Appl. No.: 18/707,455

(22) PCT Filed: Nov. 4, 2022
(86) PCT No.: PCT/IB2022/060650

§ 371 Date: May 3, 2024

Related U.S. Application Data
(60) Provisional application No. 63/278,268, filed on Nov. 11, 2021.

(51) Int. Cl. C09J 7/38; C08F 220/62; C09J 133/10

(52) U.S. Cl. CPC C09J 7/385; C08F 220/62; C09J 133/10; C09J 2301/302; C09J 2301/50; C09J 2400/263; C09J 2433/00

(57) ABSTRACT

Adhesive articles include a substrate and a hot melt processable pressure sensitive adhesive layer disposed on the substrate. The pressure sensitive adhesive layer is a (meth)acrylate-based polymer that is the cured reaction product of a mixture including a (meth)arylate monomer that is either a branched (meth)acrylate with a total of 10-17 carbon atoms or a mixture of secondary alkyl (meth)acrylate isomers with a total of 8-18 carbon atoms, a non-acid-functional polar monomer, optional acid-functional monomer, a crosslinking moiety, and an initiator. The pressure sensitive adhesive composition can be contained in a packaging material.

### SUMMARY

Disclosed herein are adhesive articles that have good adhesion to wet and dry surfaces. Also disclosed herein are adhesive compositions, methods of preparing adhesive compositions, and medical constructions that include the adhesives bonding a medical device to mammalian skin.

Disclosed herein are adhesive articles comprising a substrate with a first major surface and a second major surface, and a hot melt processable pressure sensitive adhesive layer disposed on at least a portion of the first major surface of the substrate. The pressure sensitive adhesive layer comprises a (meth)acrylate-based polymer comprising the cured reaction product of a mixture comprising: 89.0-99.49% by weight of at least one first (meth)acrylate monomer; 0.5-5.0% by weight of a non-acid-functional, ethylenically unsaturated polar monomer; 0-1% by weight of an acid-functional ethylenically unsaturated monomer; 0.01-5% by weight of at least one crosslinking moiety; and 0.01-1.0 parts by weight of at least one initiator based upon the total weight of curable components. The first (meth)acrylate monomer comprises a branched (meth)acrylate with a total of 10-17 carbon atoms or a mixture of secondary alkyl (meth)acrylate isomers with a total of 8-18 carbon atoms. The adhesion of the adhesive article to a wet PROTEIN LEATHER surface is at least 50% of its adhesion to the same dry PROTEIN LEATHER surface.

Also disclosed are adhesive compositions comprising a packaging material and a pressure sensitive adhesive, where the pressure sensitive adhesive is described above, and is contained within the packaging material. The packaged pressure sensitive adhesive is hot melt processable.

Methods of forming adhesive articles comprise providing a substrate with a first major surface and a second major surface, providing a packaged adhesive composition, disposing the packaged adhesive composition in a hot melt mixing apparatus, hot melt mixing the packaged adhesive composition, and dispensing the hot melt mixed adhesive composition onto at least a portion of the second major surface of the substrate surface to form a pressure sensitive adhesive layer. The packaged adhesive composition is described above.

Also disclosed herein are medical constructions comprising a surface comprising mammalian skin, and a medical article adhesively bonded to the surface, where the medical article comprises a medical device, and a pressure sensitive adhesive layer. The pressure sensitive adhesive layers have been described above.

### DETAILED DESCRIPTION

The use of adhesive products in the medical industry has long been prevalent and is increasing. However, while adhesives and adhesive articles have shown themselves to be very useful for medical applications, there are also issues in the use of adhesives and adhesive articles. While many medical adhesive articles are directly applied to wound areas, a wide range of medical articles, such as tapes and drapes, are not applied to the wound area itself but rather play a supporting role to treatment such as holding absorbent materials or medical devices in place on the skin. Examples of medical devices that are held in place with tapes include tubing, catheters, ostomy appliances, sensors, and the like.

Medical adhesives have a wide array of desired properties. Among these properties are the typical adhesive requisites of sufficient peel adhesion and shear holding power, as well as flexibility so as to bend with the body, and be removable without causing skin damage. Because human skin is living tissue, it is variable, since the skin surface can be relatively dry at times and can also be wet due to sweating, and the skin surface is subject to a wide range of external fluids such as bodily fluids as well as cleaning fluids. Therefore, there is a need for medical adhesives that are able to adhere to wide range of skin surfaces including both wet and dry surfaces.

Disclosed herein are adhesive articles that comprise a substrate with a first major surface and a second major surface, and a hot melt processable (meth)acrylate-based pressure sensitive adhesive layer disposed on at least a portion of the first major surface of the substrate. The substrate can be a polymeric film, a tape backing, or a medical device. The pressure sensitive adhesive comprises a (meth)acrylate-based polymer and may comprise optional additives such as tackifying resins. The (meth)acrylate-based polymer is prepared by polymerizing a reaction mixture. In some embodiments, the hot melt processable adhesive is present within a packaging material.

The term “adhesive” as used herein refers to polymeric compositions useful to adhere together two adherends. Examples of adhesives are pressure sensitive adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate-based” are materials that contain one or more (meth)acrylate and may contain additional co-polymerized free radically polymerizable materials.

The terms “free radically polymerizable” and “ethylenically unsaturated” are used interchangeably and refer to a reactive group which contains a carbon-carbon double bond which is able to be polymerized via a free radical polymerization mechanism.

The term “branched” when used to describe an alkyl (meth)acrylate refers to the alkyl group, where the branching is not present at the carbon directly adjacent to the ester group, i.e. H₂C═CR¹—C(O)—O—CH₂—R^{a}, where C(O) refers to a carbonyl group C═O, and the branching occurs in the R^{a} group. This is in contrast to a secondary alkyl (meth)acrylate where there are 2 alkyl groups bonded to the carbon directly adjacent to the ester group, i.e. H₂C═CR¹—C(O)—O—CR^{b}R^{c}, where C(O) refers to a carbonyl group C═O, and R and R are each alkyl groups.

The terms “room temperature” and “ambient temperature” are used interchangeably to mean temperatures in the range of 20° C. to 25° C.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “PROTEIN LEATHER” is used herein, according to its commonly understood meaning. Protein leather, also known as Pleather, is composed of protein powder along with resin to form pliable sheets. These sheets are a look-alike to leather in appearance as well as durability.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, ethylhexyl, n-dodecyl, 2-dodecyl, 3-dodecyl, 4-dodecyl, and 5-dodecyl.

Disclosed herein are adhesive articles. The adhesive articles comprise a substrate with a first major surface and a second major surface, and a hot melt processable (meth)acrylate-based pressure sensitive adhesive layer disposed on at least a portion of the first major surface of the substrate.

A wide range of substrates are suitable for the adhesive articles of this disclosure. Generally, the substrates are ones that are useful in medical applications. Examples of suitable substrates include a polymeric film, a tape backing, or a medical device. The substrate may be a monolithic construction or a multi-layer construction. In the multi-layer constructions, the substrate may have a variety or coatings or layers present either adjacent to or as the first or second surface of the substrate.

A wide range of polymeric film substrates are suitable, including release liners. Release liners are sheet materials that have a low adhesion coating on at least one surface. The hot melt processable pressure sensitive adhesives of the present disclosure can be disposed on a release liner to generate an article comprising a layer of pressure sensitive adhesive on a release liner. This adhesive/release liner article can be used to prepare other adhesive/substrate articles by laminating the adhesive layer to different substrate and then removing the release liner. This permits the adhesive to be disposed onto substrates to which it is difficult to directly dispose the hot melt processable pressure sensitive adhesive, such as substrates that are thermally sensitive. The adhesive/release liner article may also be used to apply the pressure sensitive adhesive layer to an article such as, for example, an electrode, an ostomy device, or the like. Typically, the film material is rigid enough to provide support to the adhesive article. Besides release liners, other suitable film layers include those that when applied to an anatomical surface, are able to conform to the surface even when the surface is moved and can stretch and retract. In some embodiments, the film material is an elastomeric polyolefin, polyurethane, polyester, or polyether block amide films.

In some embodiments, the substrate is a tape backing. Examples of suitable tape backings include breathable conformable backings. A wide range of breathable conformable backings are suitable for use in articles of this disclosure. Typically, the breathable conformable backing comprises a woven or knit textile, a nonwoven, a foam, or a plastic.

In some embodiments, the breathable conformable backing comprises a high moisture vapor permeable film backing. Examples of such backings, methods of making such films, and methods for testing their permeability are described, for example, in U.S. Pat. Nos. 3,645,835 and 4,595,001. Typically, such backings are porous materials.

Generally, the backing is conformable to anatomical surfaces. As such, when the backing is applied to an anatomical surface, it conforms to the surface even when the surface is moved. Generally, the backing is also conformable to animal anatomical joints. When the joint is flexed and then returned to its unflexed position, the backing stretches to accommodate the flexion of the joint, but is resilient enough to continue to conform to the joint when the joint is returned to its unflexed condition.

Examples of particularly suitable backings can be found in U.S. Pat. Nos. 5,088,483 and 5,160,315, and include elastomeric polyurethane, polyester, or polyether block amide films. These films have a combination of desirable properties including resiliency, high moisture vapor permeability, and transparency.

The articles may include additional optional layers. In some embodiments, it may be desirable for there to be a primer layer between the substrate surface and the pressure sensitive adhesive layer. Generally, the primer layer comprises materials that are commonly referred to as “primers” or “adhesion promoters”. Primers and adhesion promoters are materials that are applied as thin coatings on a surface and strongly adhere to the surface and provide a modified surface chemistry to the surface. Examples of suitable coating materials include polyamides, poly(meth)acrylates, chlorinated polyolefins, rubbers, chlorinated rubbers, polyurethanes, siloxanes, silanes, polyester, epoxies, polycarbodiimides, phenolics, and combinations thereof. Typically, the articles of this disclosure do not require primer layers since, when the hot melt processable pressure sensitive adhesives is disposed on the substrate surface it tends to form strong interactions with a wide range of substrate surfaces, making primers unnecessary.

In some embodiments, it may be desirable that the second major surface of the substrate, that is to say the surface on which the adhesive construction is not coated, have a low adhesion coating. This is especially true if the adhesive article is to be supplied in the form of a tape. Many tapes are supplied as rolls, where the adhesive layer contacts the non-adhesive “back” side of the backing upon being rolled up. Often this non-adhesive surface of the backing has a low adhesion or release coating on it to permit the roll to be unwound. These low adhesion coatings are often called “low adhesion backsizes” or LABs. Many factors control whether an LAB coating is necessary or desirable, including the nature of the adhesive, the composition and topography of the backing, and the desired use for the tape article.

The substrate layer has a wide range of thicknesses. Some substrates, such as foam substrates are relatively thick, other substrates, such as film substrates can be relatively thin. In some embodiments, the thickness is at least 10 micrometers, up to 2 millimeters, in some embodiments at least 10 micrometers, up to 152 micrometers (6 mils), and in yet other embodiments the thickness is from 25 micrometers (1 mil) up to 102 micrometers (4 mils) thick. A wide range of intermediate thicknesses are also suitable.

In some embodiments, the substrate comprises a medical device. A wide range of medical devices are suitable, including devices meant to be worn for a short period of time or a long period of time. Examples include a wide array of monitors, pumps, electrodes, sensors, and communication modules that are attached to patients. Examples of such devices include RFID, Insulin pumps, BME (BioMedical Electrode), Continuous Glucose Monitors, Flash Glucose Monitors, and the like.

The adhesive article also comprises a hot melt processable pressure sensitive adhesive layer disposed on at least a portion of the first major surface of the substrate, the pressure sensitive adhesive layer comprising a (meth)acrylate-based polymer and optional additives.

Disclosed herein are adhesive compositions that are hot melt processable. The term “hot melt processable” is not a process description or limitation, but rather is a material description, meaning that the adhesive compositions are capable of being hot melt processed, and not that the compositions necessarily have been hot melt processed.

In some embodiments, the (meth)acrylate-based polymer comprises a cured reaction product of a mixture comprising:
89.0-99.49% by weight of at least one first (meth)acrylate monomer;
0.5-5.0% by weight of a non-acid-functional, ethylenically unsaturated polar monomer;
0-1% by weight of an acid-functional ethylenically unsaturated monomer;
0.01-5% by weight of at least one crosslinking moiety; and
0.01-1.0 parts by weight of at least one initiator based upon the total weight of curable components.

A reaction mixture is prepared with the desired composition reactive components and is then polymerized to form the (meth)acrylate-based polymer. The reaction mixture, as stated above, comprises at least a first (meth)acrylate monomer, a non-acid-functional, ethylenically unsaturated polar monomer, optionally may contain an acid-functional ethylenically unstatured monomer, a crosslinking moiety, and at least one initiator. In addition, the reactive mixture may comprise one or more optional components as is described below.

The first (meth)acrylate monomer comprises a branched (meth)acrylate with a total of 10-17 carbon atoms or a mixture of secondary alkyl (meth)acrylate isomers with a total of 8-18 carbon atoms.

In embodiments where the first (meth)acrylate monomer comprises a branched alkyl (meth)acrylate, with 10-17 carbon atoms. The branched alkyl (meth)acrylate is of the general formula H₂C═CR¹—C(O)—O—CH₂—R^{a}, where C(O) refers to a carbonyl group C═O, and the branching occurs in the R^{a} group. Particularly suitable is iso-decyl acrylate.

In embodiments where the first (meth)acrylate monomer comprises a mixture of secondary alkyl (meth)acrylate isomers with a total of 8-18 carbon atoms. In some embodiments, the mixture of secondary alkyl (meth)acrylate isomers comprises a mixture at least 5 isomers. In some embodiments, the first (meth)acrylate comprises a mixture of secondary alkyl (meth)acrylate isomers of Formula (I):

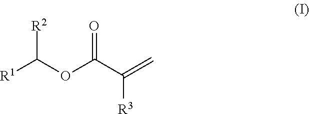

where R¹ and R² are each independently a C₁ to C₁₀ saturated linear alkyl group, the sum of the number of carbons in R¹ and R² is 8 to 18; and R³ is H or CH₃. In some embodiments, R¹ and R² are each independently a C₁ to C₁₀ saturated linear alkyl and the sum of the number of carbons in R¹ and R² is 9 to 17. In other embodiments, R¹ and R² are each independently a C₁ to C₁₀ saturated linear alkyl and the sum of the number of carbons in R¹ and R² is 9 to 13. The mixtures of monomers have been described in, for example U.S. Pat. No. 9,102,774.

The first (meth)acrylate monomer or mixture of monomers is the primary component of the reaction mixture comprising at least 89% by weight based on the weight of the total reactive monomers, and up to 99.49% by weight. In some embodiments, the first (meth)acrylate is present in an amount of at least 90%, 91%, 92%, 93%, 94%, 95%, 96%, 97%, 98%, or 99%.

The composition used to form the pressure-sensitive adhesive polymer may further include a polar monomer. As used herein, the term “polar monomer” is exclusive of acid-functionality and is referred to as a “non-acid-functional, ethylenically unsaturated polar monomer”.

Representative examples of suitable such polar monomers include, but are not limited to, 2-hydroxyethyl (meth)acrylate; 4-hydroxybutyl (meth)acrylate; N-vinylpyrrolidone (NVP); N-vinylcaprolactam (NVC); acrylamide; mono- or di-N-alkyl substituted acrylamide; t-butyl acrylamide; dimethylaminoethyl acrylamide; N-octyl acrylamide; a poly(alkoxyalkyl) (meth)acrylate including 2-(2-ethoxyethoxy)ethyl (meth)acrylate, 2-ethoxyethyl (meth)acrylate, 2-methoxyethoxyethyl (meth)acrylate, 2-methoxyethyl methacrylate, and a polyethylene glycol mono(meth)acrylate; an alkyl vinyl ether, including vinyl methyl ether; and mixtures thereof. Particularly suitable polar monomers include those selected from the group consisting of NVP (N-vinyl pyrrolidone), NVC (N-vinylcaprolactam), acrylamide mono- or di-N-alkyl substituted acrylamide, t-butyl acrylamide, dimethylaminoethyl acrylamide or N-octyl acrylamide, and mixtures thereof.

The non-acid-functional, ethylenically unsaturated polar monomer is present in an amount of at least 0.5 and up 5% by weight, based on the total weight of monomers. In some embodiments, the non-acid-functional, ethylenically unsaturated polar monomer is present in an amount of at least 1.0, 1.5, 2.0, 2.5, 3.0, 3.5, 4.0, or 4.5% by weight.

The reaction mixture may optionally include an acid-functional monomer, wherein the acid-functional group may be an acid per se, such as a carboxylic acid, or a portion may be salt thereof, such as an alkali metal carboxylate. Useful acid-functional monomers include, but are not limited to, those selected from an ethylenically unsaturated carboxylic acid, ethylenically unsaturated sulfonic acid, ethylenically unsaturated phosphonic acid, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

The acid monomer, if present, is up to 1% by weight based on the total weight of monomers. In some embodiments, the acid-functional monomer is present in an amount of up to 0.1, 0.2, 0.3, 0.4, 0.5, 0.6, 0.7, 0.8, 0.9% by weight.

The reaction mixture also comprises at least one crosslinking moiety. A wide variety of crosslinking moieties are suitable. In some embodiments, the crosslinking moiety is a photocrosslinker. In other embodiments, the crosslinking moiety is a multi-functional (meth)acrylate. In yet other embodiments, the crosslinking moiety is a combination of photocrosslinker and multi-functional (meth)acrylate.

Photocrosslinkers are co-polymerizable, having a free radically polymerizable group to co-polymerize with the monomers described above. The co-polymerizable photocrosslinkers also contain a photosensitive group that upon exposure to the right wavelength of light, typically high intensity ultra-violet (UV) radiation, the photosensitive group forms free radicals which can form crosslinks in the polymer. If the (meth)acrylate-based polymer is formed by the use of a photoinitiator, the photocrosslinker is not activated by the same wavelengths of light as the photoinitiator. In this way, the co-polymerizable photocrosslinker is incorporated into the polymer, and is able to be thermally processed, as the crosslinker is thermally stable and remains intact until activated by the proper wavelength of light. This permits the co-polymerizable photocrosslinker from becoming activated until the polymer has been hot melt coated. In some embodiments, these crosslinkers are activated by UV light generated from artificial sources such as medium pressure mercury lamps or a UV blacklight.

Suitable photocrosslinkers in the mono-ethylenically unsaturated aromatic ketone co0monomers that are free of ortho-aromatic hydroxyl groups such as those described in U.S. Pat. No. 4,737,559 (Kellen et al.). Specific examples include para-acryloxybenzophenone (ABP), para-acrylyoxyethoxybenzophenone, para-N-(methylacryloxyethyl)-carbamoylethoxybenzophenone, para-acryloxyacetophenone, ortho-acrylamidoacetophenone, acrylated anthraquinones, and the like. Particularly suitable is ABP para-acryloxybenzophenone also called 4-acryloxybenzophenone.

The other suitable class of crosslinking moieties are multi-functional (meth)acrylates. Examples of a useful multi-functional (meth)acrylates include, but are not limited to, a di(meth)acrylate, tri(meth)acrylate, and tetra(meth)acrylate, such as 1,6-hexanediol di(meth)acrylate, a poly(ethylene glycol) di(meth)acrylate, polybutadiene di(meth)acrylate, a polyurethane di(meth)acrylate, propoxylated glycerin tri(meth)acrylate, and mixtures thereof. The multi-functional (meth)acrylates crosslink the (meth)acrylate polymer during the polymerization process.

The crosslinking moiety, whether a photocrosslinker, a multi-functional (meth)acrylate, or combination thereof is present in an amount of at least 0.01% and up to 5% by weight based on the total weight of the total monomers. In some embodiments, the crosslinking moiety is present in an amount at least 0.1, 0.5, 1.0, 1.5, 2.0, 2.5, 3.0, 3.5, 4.0, or 4.5% by weight.

The reaction mixture also comprises at least one initiator. Typically, the initiator is a photoinitiator, meaning that the initiator is activated by light, typically ultraviolet (UV) light. Photoinitiators are well understood by one of skill in the art of (meth)acrylate polymerization. Examples of suitable free radical photoinitiators include DAROCURE 1173, DAROCURE 4265, IRGACURE 184, IRGACURE 651, IRGACURE 1173, IRGACURE 819, LUCIRIN TPO, LUCIRIN TPO-L, commercially available from BASF, Charlotte, NC. The photoinitiator DAROCURE 1173 is particularly suitable.

Generally, the photoinitiator is used in amounts of 0.01 to 1 part by weight, more typically 0.1 to 0.5 parts by weight relative to 100 parts by weight of total reactive components.

The reaction mixture may also comprise a variety of optional additives as long as the additives do not adversely affect the polymerization reaction. One particularly suitable additive is a chain transfer agent. Examples of useful chain transfer agents include, but are not limited to, those selected from the group consisting of carbon tetrabromide, mercaptans, alcohols, and mixtures thereof. A particularly suitable chain transfer agent is IOTG (isooctyl thioglycolate). Chain transfer agents and the use of chain transfer agents is well understood in the adhesive arts.

The above described reaction mixtures are polymerized to form the (meth)acrylate-based polymer. The pressure sensitive adhesive layer of the adhesive articles comprise this (meth)acrylate-based polymer and may also comprise additional additives as are described below. The polymerization of the reaction mixture can be carried out using a variety of conventional free radical polymerization methods, including solvent-based and solventless processes.

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of 40 to 100° C. until the reaction is completed, typically in 1 to 20 hours, depending upon the batch size and temperature. Examples of the solvent are methanol, tetrahydrofuran, ethanol, isopropanol, acetone, methyl ethyl ketone, methyl acetate, ethyl acetate, toluene, xylene, and ethylene glycol alkyl ether. Those solvents can be used alone or as mixtures thereof.

Solventless polymerization methods may also be utilized to prepare the polymers, such as the continuous free radical polymerization method described in U.S. Pat. No. 4,619,979 (Kotnour et al.) and U.S. Pat. No. 4,843,134 (Kotnour et al.), the essentially adiabatic polymerization methods using a batch reactor described in U.S. Pat. No. 5,637,646 (Ellis), and, the methods described for polymerizing packaged pre-adhesive compositions described in U.S. Pat. No. 5,804,610 (Hamer et al.).

The pressure sensitive adhesive layer comprises the (meth)acrylate-based polymer and may also contain one or more conventional additives. Suitable additives include tackifiers, plasticizers, dyes, antioxidants, and UV stabilizers as long as the additives do not adversely affect the adhesive properties of the adhesive layer.

Tackifying resins are particularly suitable for use in the pressure sensitive adhesive layers of the adhesive articles. Suitable tackifying resins include rosins and their derivatives (e.g., rosin esters); polyterpenes and aromatic-modified polyterpene resins; coumarone-indene resins; and hydrocarbon resins such as alpha pinene-based resins, beta pinene-based resins, limonene-based resins, aliphatic hydrocarbon-based resins, aromatic-modified hydrocarbon-based resins, aromatic hydrocarbon resins, and dicyclopentadiene-based resins. In certain embodiments, the tackifier is a terpene resin, a hydrocarbon resin, a rosin resin, a petroleum resin, or combination thereof. Combinations of various tackifiers can be used if desired. These tackifying resins, if desired, can be hydrogenated to lower their color contribution to the pressure-sensitive adhesive layer.

The tackifying resin if used is typically present in the pressure sensitive adhesive layer in an amount of 2-25 parts of tackifier per 100 parts of the (meth)acrylate-based polymer.

The adhesive articles of the current disclosure have a wide range of desirable properties. Among the desirable properties are adhesion of both wet and dry surfaces. This property renders the adhesive articles suitable for use on wet or dry skin. The adhesion of adhesive articles to wet or dry skin can be modeled in a variety of ways. In this disclosure, PROTEIN LEATHER is used as a particularly suitable test surface. PROTEIN LEATHER refers to artificial leather (sometimes called pleather) that is composed of protein powder along with resin to form pliable sheets. These sheets are a look-alike to leather in appearance as well as durability. The use of PROTEIN LEATHER in testing of samples is explained in detail in the Examples section. One particularly suitable PROTEIN LEATHER is PROTEIN LEATHER PBZ13001 KAKI form IDEATEX Japan Co.

The current adhesive articles have adhesion to a wet PROTEIN LEATHER surface is at least 50% of its adhesion to the same dry PROTEIN LEATHER surface. In some embodiments, the adhesion to a wet PROTEIN LEATHER surface is at least 55%, at least 60%, at least 65%, or even at least 70% of its adhesion to the same dry PROTEIN LEATHER surface.

In some embodiments, the adhesive article has adhesion to a wet PROTEIN LEATHER surface of at least 1 Newton/25 millimeters. In some embodiments, the adhesive article has adhesion to a wet PROTEIN LEATHER surface of at least 1.5, at least 2, at least 2.5 or even at least 3.0 Newton/25 millimeters.

The pressure sensitive adhesive layer has a desirable modulus. In many embodiments, the adhesive layer is hot melt processed, and often hot melt processed pressure sensitive adhesives have a low modulus that can lead to a number of undesirable properties. In some embodiments, the pressure sensitive adhesive has a modulus of greater than 10,000 Pascals at 25° C. as measured by DMA (Dynamic Mechanical Analysis).

Another desirable property of the current pressure sensitive adhesive layers is a relative lack of orientation compared to what is expected for hot melt processed adhesive layers. It is well-known in the adhesive arts that hot melt processing tends to produce adhesive layers that are oriented when compared with, for example, adhesive layers produced with solvent-borne adhesives that are coated and dried. For example, it has been observed with optical adhesives that hot melt processing generates birefringence in the adhesive layer. In the current medical articles, orientation in the pressure sensitive adhesive layers is undesirable, especially in pressure sensitive adhesives that have a modulus of greater than 10,000 Pascals as described above. The orientation is undesirable because orientation can interfere with the wet out of the pressure sensitive adhesive layer to surfaces, especially surfaces that are not smooth. Additionally, the stress present in oriented adhesive layers can over time cause curling of the adhesive layer (where the edge of the lifts up for the adhered surface and bends away from the adhered surface) or other adhesive failure modes.

The amount of orientation present in an adhesive layer can be measured in a variety of different ways. In the Examples section a Shrinkage Test is described that provides a method for characterizing orientation. Because an oriented adhesive layer has stress built into it, the oriented adhesive layer cause shrinkage of articles.

Also disclosed are adhesive compositions. These compositions can be used to form the pressure sensitive adhesive layer of the adhesive articles described above. The adhesive composition comprises a packaging material and a pressure sensitive adhesive, where the pressure sensitive adhesive is contained within the packaging material, and the packaged pressure sensitive adhesive is hot melt processable. The pressure sensitive adhesive comprises a (meth)acrylate polymer comprising the cured reaction product of a mixture comprising:
89-99.49% by weight of at least one first (meth)acrylate monomer;
0.5-5.0% by weight of a non-acid-functional, ethylenically unsaturated polar monomer;
0-1% by weight of an acid-functional ethylenically unsaturated monomer;
0.01-5% by weight of at least one crosslinking moiety; and
0.01-1.0 parts by weight of at least one initiator based upon the total weight of curable components. The reactive components and properties of the pressure sensitive adhesive have been described in detail above.

Also disclosed are methods of forming adhesive articles. In some embodiments, the method comprises providing a substrate with a first major surface and a second major surface, providing a packaged adhesive composition, disposing the packaged adhesive composition in a hot melt mixing apparatus, hot melt mixing the packaged adhesive composition, and dispensing the hot melt mixed adhesive composition onto at least a portion of the first major surface of the substrate surface to form a pressure sensitive adhesive layer.

Suitable substrates are also described in detail above. The packaged adhesive compositions are also described in detail above. In some embodiments. disposing the packaged adhesive composition in a hot melt mixing apparatus further comprises adding a tackifier to the hot melt mixing apparatus. Typically, the tackifier, if used, is added at a level of 2-25 parts by weight based upon 100 parts of the (meth)acrylate-based polymer.

Also disclosed are medical constructions, where the medical constructions comprise a surface comprising mammalian skin and a medical article adhesively bonded to the surface. The medical article comprises a medical device with a first major surface and a second major surface, where the medical device has a pressure sensitive adhesive layer disposed on at least a portion of the second major surface of the medical device. The pressure sensitive adhesives are the hot melt processable (meth)acrylate-based adhesives described above.

A wide range of medical devices are suitable. In some embodiments, comprises a wide array of medical devices including monitors, pumps, electrodes, sensors, and communication modules as described above.

### Examples

These examples are merely for illustrative purposes only and are not meant to be limiting on the scope of the appended claims. All parts, percentages, ratios, etc. in the examples and the rest of the specification are by weight, unless noted otherwise. The following abbreviations are used: cm=centimeters; mm=millimeters; nm=nanometers; dm=decimeters; in =inch; RPM=revolutions per minute; Hz=Hertz; g=grams; kg=kilograms; lb=pounds; oz=ounces; ml=milliliters; Pa=Pascals; μ-Nm=micrometer-Newton meter; mW=milliWatts; mJ=milliJoules; min=minutes.

### Materials Used in the Examples

| Abbreviation | Description |
|---|---|
| AA | Acrylic acid, obtained from Alfa Aesar, Heysham, |
| | England |
| NVP | N-vinylpyrrolidone, obtained from Ashland, Wilmington, |
| | DE. |
| IOA | Isooctyl acrylate, made in-house at 3M by standard |
| | procedures |
| ISOMER | A mixture of 2-octyl acrylate, 3-octyl acrylate, and 4- |
| MIX A | octyl acrylate, prepared as in Example 1 of U.S. Pat. No. |
| | 9,102,774 (Clapper et al.) |
| ISOMER | A mixture of 2-dodecyl acrylate, 3-dodecyl acrylate, 4- |
| MIX B | dodecyl acrylate, 5-dodecyl acrylate, and 6-dodecyl |
| | acrylate prepared as in Example 9 of U.S. Pat. No. |
| | 9,102,774 (Clapper et al.) |
| Photointiator | 2-Hydroxy-2-methyl-1-phenylpropanone, formerly |
| | known as “IRGACURE 1173”, a photoinitiator obtained |
| | under the trade designation “OMNIRAD 1173” from |
| | IGM Resins USA, Inc., Charlotte, NC |
| Ethyl Acetate | Ethyl acetate, obtained from Honeywell, Charlotte, NC |
| THF | Tetrahydrofuran stabilized with 250 ppm BHT, obtained |
| | from MilliporeSigma Co., Burlington, MA |
| KAEBP | Ketalated acryloxyethoxybenzophenone, prepared |
| | generally as described in Example 1 of U.S. Pat. No. |
| | 10,189,771 (Benson et al.) |
| ABP | 4-Acryloxy benzophenone made in-house at 3M by |
| | standard procedures |
| Antioxidant 1 | Tetrakis(methylene(3,5-di-tert-butyl-4- |
| | hydroxyhydrocinnamate))methane, available under the |
| | trade designation “Irganox 1010” from BASF |
| | Corporation, Vandalia, Illinois |
| Antioxidant 2 | Octadecyl-3-[3,5-di-tert-butyl-4- |
| | hydroxyphenyl]propionate, an antioxidant obtained under |
| | the trade designation “IRGANOX 1076” from BASF, |
| | Ludwigshafen, Germany |
| HDDA | 1,6-Hexanediol acrylate, obtained under the trade |
| | designation “LAROMER HDDA” from BASF Corp, |
| | Florham Park, NJ |
| EVA film | A clear poly(ethylene vinyl acetate) film, 0.065 mm |
| | thick, which was produced using a blown film process |
| | from an EVA copolymer resin obtained under the trade |
| | designation “ELEVATE EF546AA” from Westlake |
| | Chemical Corporation, Houston, TX |
| ARKON P-125 | Water white, hydrocarbon resin obtained under the trade |
| | designation “ARKON P-125” from Arakawa Chemical, |
| | Chicago, IL |
| ARKON P-100 | Water white, hydrocarbon resin obtained under the trade |
| | designation “ARKON P-100” from Arakawa Chemical, |
| | Chicago, IL |

### Preparation of “100% Solids” or “Bulk” Polymers Used in the Examples

Monomer mixtures were prepared by blending reactive acrylic monomers, photoinitiator and antioxidant, in a jar. To this mixture was added a magnetic stir bar, and the mixture was placed on a stir plate, forming a curable composition. EVA film was heat sealed to form open ended receptacles each measuring 18 cm by 5 cm. Each receptacle was filled with approximately 24 grams of the curable composition. Air was forced out of the open end which was then sealed using a heat sealer (obtained under the trade designation “MIDWEST PACIFIC IMPULSE SEALER” from J. J. Elmer Corp., St. Louis, MO). A sealed EVA film receptacle having the curable composition enclosed within the was immersed in a constant temperature water bath at 16° C. and irradiated with ultraviolet light (365 nm, 4.5 mW/cm²) for nine minutes on each side to polymerize the curable composition. Polymerized samples were removed from the EVA film receptacle for testing, as described below.

### Test Methods

### Test Method 1: Determination of Gel Content

A rectangular polymer sample of approximately 24 g was placed onto the center of a pre-weighed rectangular mesh. The mesh was a square weave wire cloth, stainless steel type 304, of woven construction, 150 mesh, using 0.0026 inch (66 micrometer) wire, and 0.0041 inch (104 micrometer) openings (obtained under the trade designation “MCMASTER-CARR”, from McMaster-Carr Co., Elmhurst, IL). The overhanging portion of the mesh was folded inwards to cover and immobilize the sample inside the mesh. The folded mesh with the enclosed polymer was weighed and then immersed in approximately 8 oz. (approx. 240 ml) of ethyl acetate inside a glass jar that was placed on a mechanical roller for 24 hours. The mesh with the polymer was then taken out of the jar and dried in an oven for 30 minutes at 120° C. and weighed again to calculate the sample mass. The gelled insoluble portion of the polymer was calculated as a gel weight percent (“gel wt. %”) using the following equation:

$$Gel Wt . \% = \frac{\begin{matrix}( final weight of undissolved polymer + mesh ) - \\ ( weight of mesh )\end{matrix}}{\begin{matrix}( initial weight of polymer + mesh ) - \\ ( weight of mesh )\end{matrix}} \times 100$$

### Test Method 2: Determination of Rheological Profile

DMA was used to measure the storage modulus, viscosity, and glass transition temperatures of pre-adhesive compositions. A small sample of pre-adhesive composition was transferred onto the bottom plate of a rheometer (obtained from TA Instruments, New Castle, Del., under the trade designation “ARES G2 RHEOMETER”). The rheometer had parallel 8 mm diameter top and 25 mm bottom plates. The top plate of the rheometer was brought down onto the sample of pre-adhesive composition until the parallel plates were separated by 1 mm. Excess material was trimmed away from the edge of the 8 mm top plate. A temperature ramp test method was used where shear moduli, viscosity, and tan(6) were estimated while sample was subjected to oscillatory shear (frequency=1 Hz) and at the same time the sample temperature was continuously increased from −75° C. to 150° C. at a rate of 3° C./min. The strain amplitude was 0.05% at −75° C. increasing with temperature to 3.6% iteratively as needed to achieve a minimum torque of 10 μ-Nm. Storage modulus (G′) was reported in Pa. Viscosity (i) of the pre-adhesive composition was reported in Pascal-seconds (Pa-s). Tan (6) was calculated as the ratio of G″/G′ (loss modulus/storage modulus). The temperature where the tan(6) curve had a local peak was reported as the glass transition temperature (“Tg”).

### Test Method 3: Shrinkage Test

A square of adhesive on release liner measuring 10 cm by 10 cm was cut and folded on itself parallel to the coating direction of the solventless adhesive. Gentle pressure was applied, and the release liner was removed from the top. To the adhesive sample now measuring 10 cm by 5 cm, the adhesive was again folded parallel to the coating direction with gentle application of pressure, resulting in a 10 cm by 2.5 cm sample. The process of folding and applying pressure was repeated one additional time, resulting in a final sample dimension of 10 cm (length) by 1.25 cm (width) and defined as the unrelaxed length. This adhesive sample was then placed in a bed of talc and the adhesive in talc was warmed to 65° C. for 3 minutes. The length of the sample was then measured to give the “relaxed” sample length. The shrinkage of the sample was defined as (“unrelaxed length”−“relaxed length”)/“relaxed length.

### Test Method 4: Peel Adhesion to Dry VITRO-SKIN (Strips)

An artificial skin substrate was obtained from IMS Inc. (Portland, ME) under the trade designation VITRO-SKIN (this material, as supplied, is formulated to mimic the topography, pH, critical surface tension etc. of human skin.) Dry adhesion to VITRO-SKIN was assessed using strips of foam tape. A piece of VITRO-SKIN approximately 2 inches wide×6 inches long (5×15 cm) was cut and placed on a stainless steel plate using double stick tape. Samples for dry skin adhesion testing were produced in the form of adhesive-coated foam tape. A piece of masking tape approximately 2 inches wide×6 inches long (5×15 cm) was applied to the backing of the foam tape in order to reinforce the foam and prevent the foam from stretching. A sample approximately 1 inch wide×6 inches long (2.5×15 cm) was then cut from the foam tape reinforced by masking tape. The foam tape test sample was applied to the VITRO-SKIN on the stainless steel plate using 2 passes with a 4.51b (2 kg) roller (down and back). The average force to remove the foam tape from the VITRO-SKIN at 180 degrees was then determined using a Zwick instrument at a testing speed of 12 inches/minute (30 cm/min).

### Test Method 5: Peel Adhesion to Wet VITRO-SKIN (Strips)

An artificial skin substrate was obtained from IMS Inc. (Portland, ME) under the trade designation VITRO-SKIN (this material, as supplied, is formulated to mimic the topography, pH, critical surface tension etc. of human skin.) An artificial sweat liquid was made to mimic the properties of human sweat. A first ingredient (artificial sebum) was a mixture of 5.5 g of olive oil, 2.5 g of oleic acid, and 2.0 g of squalene. A second ingredient was a mixture of 3.75 g of sodium chloride, 0.75 g of urea and 0.75 g of lactic acid. The second ingredient was diluted to 750 mL in water and the pH was adjusted to 6.5 by use of NH₄OH. 0.375 g of the first ingredient was then vigorously mixed with the 750 ml of the second ingredient to make the artificial sweat.

Wet adhesion to VITRO-SKIN was assessed using strips of foam tape. A piece of artificial skin approximately 2 inches wide×6 inches long was cut and placed on a stainless steel plate using double stick tape. The artificial sweat solution was sprayed onto the artificial skin substrate 5 times from a small spray bottle.

Samples for wet skin adhesion testing were produced in the form of adhesive-coated foam tape. A piece of masking tape approximately 2 inches wide×6 inches long was applied to the backing of the foam tape in order to reinforce the foam and prevent the foam from stretching. A sample approximately 1 inch wide×6 inches long (2.5×15 cm) was then cut from the foam tape reinforced by masking tape. The foam tape test sample was applied to the VITRO-SKIN wetted with the artificial sweat solution on the stainless steel plate using 2 passes with a 4.51b (2 kg) roller (down and back). The test sample was allowed to dwell on the wet artificial skin for 2 minutes.

The average force to remove the foam tape from the wet VITRO-SKIN at 180 degrees was then determined using a Zwick instrument at a testing speed of 12 inches/minute (30 cm/min).

### Test Method 6: Pull Force on Wet PROTEIN LEATHER (Electrodes)

Rolls of adhesive were converted to the 3M 2560 electrode form factor following the standard manufacturing practice used to prepare commercial electrodes. Wet substrate samples were prepared by cutting 65 mm by 120 mm sections of PROTEIN LEATHER PBZ13001 KAKI (obtained from IDEATEX Japan Co. Ltd.) and submerging them in a bath of synthetic sweat containing 0.5% w/v synthetic sebum for approximately 30 minutes. Samples were removed from the bath and sprayed 5 times with the sweat solution containing 0.5% w/v synthetic sebum using a 4 oz spray bottle (Uline Model #S-20078). Electrode samples were applied by hand to the PROTEIN LEATHER substrate immediately followed by placing a 275 gram weight on top of the electrode for 5 seconds. A sample dwell time of 1 minute was used prior to connecting the stud to an electrode lead wire and pulling at 90 in/min until failure on an IMASS. The peak kinetic force of 5 samples was measured, averaged, and recorded.

### Test Method 7: Peel Adhesion to Dry PROTEIN LEATHER (Strips)

25 mm×125 mm size tape sample was laminated on 30 mm×125 mm size PROTEIN LEATHER PBZ13001 KAKI (obtained from IDEATEX Japan Co. Ltd.) by using 2 kg roller. The applied tape was removed with T-peel with 150 mm/min (for hotmelt) or 300 mm/min (for solvent) test speed by using TENSILON (A&D company Ltd.) (for hotmelt) or SP-2100 (IMASS) (for solvent), then we measured average peel force upon removal.

### Test Method 8: Peel Adhesion to Wet PROTEIN LEATHER (Strips)

Synthetic sweat dispersion was sprayed on to PROTEIN LEATHER PBZ13001 KAKI (obtained from IDEATEX Japan Co. Ltd.), and dwell for 20-40 min. after wiping the protein leather, synthetic sweat dispersion was sprayed again (5 times spraying). Then T-peel adhesion was measured by repeating the procedure described in Test Method 7.
Synthetic sweat dispersion: Synthetic sweat dispersion is used for wet stick test, and it was prepared by mixing the following material.
   Synthetic sweat dispersion: 750 ml Synthetic sweat+0.75 g Synthetic sebum

| | | | |
|---|---|---|---|
| Synthetic sweat | Sodium chloride | 3.75 | g |
| | Urea | 0.75 | g |
| | Lactic Acid | 0.75 | g |
| | 10% Ammonium hydroxide | 1.5 | g |
| | solution | | |
| | Deionized Water | 750 | ml |
| Synthetic sebum | Olive oil | 5.5 | g |
| | Oleic acid | 2.5 | g |
| | Squalene | 2.0 | g |

### Examples 1-3 and Comparative Example 1: Preparation and Analysis of Alkyl Acrylate Adhesive Compositions

For each Example, the general procedure for “Preparation of ‘100% Solids’ or ‘Bulk’ Polymers” was followed by using the amounts (in parts by weight based on the total weight of IOA, ISOMER MIX A, ISOMER MIX B, and AA) listed in Table 1 to provide three Examples (Exs. 1-3).

TABLE 1
Compositions of Examples 1-3 with Different Alkyl Acrylates

| RM | 1 | 2 | 3 |
|---|---|---|---|
| IOA | 98 | — | — |
| ISOMER MIX A | — | 98 | — |
| ISOMER MIX B | — | — | 96.75 |
| AA | 2 | 2 | 3.25 |
| Photoinitiator | 0.2 | 0.2 | 0.2 |
| IOTG | 0.1 | 0.1 | 0.1 |
| HDDA | 0.06 | 0.06 | 0.06 |
| Antioxidant 1 | 0.6 | 0.6 | 0.6 |
| KAeBP | 0.3 | 0.3 | 0.3 |

Gel content measurements were performed on each of Examples 1-3. Results are summarized in Table 2.

TABLE 2
Gel Content Measurements of Examples 1-3

| Example | Gel Wt. % |
|---|---|
| 1 | 7.85 ⁺/− 1.63 |
| 2 | 11.79 ⁺/− 0.93 |
| 3 | 0.02 ⁺/− 0.03 |

A sample of material from each example in Table 1 was compounded in a twin screw extruder at 160° C. for three minutes. The resulting hotmelt was coated onto a silicone release liner using a drop die. The extrusion temperatures for the die and extruder were kept at 160° C. The extruded samples were coated at 3 mil (76 micrometers) thickness. The samples were then cured at 50 mJ/cm² of UV-C radiation using a UV fusion lamp and H-bulb. The samples were later hand laminated onto 0.0625 inch thick EVA foam obtained from Sekesui Voltek under the trade name EO Volaro using a 5 lb (2.2 kg) hand roller.

CE-1 was commercially manufactured in-house at 3M by standard procedures and used on 3M RED DOT Adhesives.

CE-1 and Examples 1-3 were tested by measuring the adhesion to VITRO-SKIN under both dry and wet conditions according to Test Methods 4 and 5 and results are summarized in Table 3.

TABLE 3
Average Peel Force to Dry and Wet
VITRO-SKIN of CE-1 and Examples 1-3

| | Adhesion (dry) | Adhesion (wet) |
|---|---|---|
| Example | g/in (N/dm) | g/in (N/dm) |
| CE-1 | 375 (14.4) | 22 (0.85) |
| 1 | 414 (15.9) | 24 (0.92) |
| 2 | 375 (14.4) | <0 |
| 3 | 387 (14.9) | 140 (5.39) |

Examples 4-10: Preparation and Analysis of Polar Comonomer Adhesive Compositions For each Example, the general procedure for “Preparation of ‘100% Solids’ or ‘Bulk’ Polymers” was followed by using the amounts (in parts by weight based on the total weight of ISOMER MIX B, AA, and NVP) listed in Table 4 to provide seven Examples (Exs. 4-10).

TABLE 4
Compositions of Examples 4-10 with Different Polar Comonomers

| RM | 4 | 5 | 6 | 7 | 8 | 9 | 10 |
|---|---|---|---|---|---|---|---|
| ISOMER MIX B | 96.75 | 96.75 | 96.75 | 98 | 96.75 | 98 | 100 |
| AA | 3.25 | 3.25 | 3.25 | 2 | — | — | — |
| NVP | — | — | — | — | 3.25 | 2 | — |
| Photoinitiator | 0.2 | 0.2 | 0.2 | 0.2 | 0.2 | 0.2 | .2 |
| IOTG | 0.1 | 0.1 | 0.07 | 0.1 | 0.1 | 0.1 | 0.1 |
| HDDA | 0.06 | 0.08 | 0.042 | 0.06 | 0.06 | 0.06 | 0.12 |
| Antioxidant 1 | 0.6 | 0.6 | 0.6 | 0.6 | 0.6 | 0.6 | 0.6 |
| KAeBP (100%) | 0.3 | 0.3 | 0.3 | 0.3 | 0.3 | 0.3 | 0.3 |

A sample of material from each example in Table 1 was compounded in a twin screw extruder at 160° C. for three minutes. The resulting hotmelt was coated onto a silicone release liner using a drop die. The extrusion temperatures for the die and extruder were kept at 160° C. The extruded samples were coated at 3 mil (76 micrometers) thickness. A portion of the samples were then cured at 50 mJ/cm² of UV-C radiation using a UV fusion lamp and H-bulb. The samples were later hand laminated onto 0.0625 inch thick EVA foam obtained from Sekesui Voltek under the trade name EO Volaro using a 5 lb (2.2 kg) hand roller.

CE-1 was commercially manufactured in-house at 3M by standard procedures and used on 3M RED DOT Adhesives.

CE-1 and Examples 1-3 were tested by measuring the adhesion to VITRO-SKIN under both dry and wet conditions according to Test Methods 4 and 5 and summarized in Table 5.

TABLE 5
Average Peel Force to Dry and Wet VITRO-
SKIN of CE-1 and Examples 4-10

| | Adhesion (dry) | Adhesion (wet) |
|---|---|---|
| Example | g/in (N/dm) | g/in (N/dm) |
| CE-1 | 375 (14.4) | 22 (0.85) |
| 4 | 603 (23.2) | 340 (13.1) |
| 5 | 414 (15.9) | 327 (12.6) |
| 6 | 367 (14.1) | 88 (3.4) |
| 7 | 474 (18.2) | 164 (6.32) |
| 8 | 1148 (44.2) | 562 (21.6) |
| 9 | 883 (34.0) | 647 (24.9) |
| 10 | 474 (18.2) | 411 (15.8) |

### Examples 11-12: Preparation and Analysis of Adhesive Compositions Containing Acidic and Basic Comonomers

For each Example, the general procedure for “Preparation of ‘100% Solids’ or ‘Bulk’ Polymers” was followed by using the amounts (in parts by weight based on the total weight of ISOMER MIX B, AA, and NVP) listed in Table 6 to provide two Examples (Exs. 11-12).

TABLE 6
Compositions of Examples 11-12 containing
Different Photocrosslinkers

| RM | 11 | 12 |
|---|---|---|
| ISOMER MIX B | 97.5 | 97.5 |
| NVP | 2 | 2 |
| AA | 0.5 | 0.5 |
| Photoinitiator | 0.2 | 0.2 |
| IOTG | 0.1 | 0.1 |
| HDDA | 0.0775 | 0.067 |
| Antioxidant 1 | 0.6 | 0.6 |
| ABP | 0 | 0.05 |
| KAeBP (50%) | 0.6 | 0 |

A sample of material from each example in Table 3 was compounded in a Bonnot Extruder from the Bonnot Company at 275° F. (135° C.) and screw speed of 30 rpm. The heated sample was pumped to a twin screw extruder at a temperature of 320° F. (160° C.) and screw speed of 200 rpm. The resulting hotmelt was coated onto a silicone release liner using a rod coater die. The extrusion temperatures for the die and extruder were kept at 320° F. (160° C.). The extruded sample was coated at 3 mil (76 micrometers) thickness. The samples were then immediately cured at 60 mJ/cm² of UV-C radiation using a UV fusion lamp and H-bulb. The samples were then covered with EVA foam and wound into a roll.

The roll of adhesive was converted to the electrode form factor using standard manufacturing practice used to prepare commercial electrodes.

Examples 11-12 were tested by measuring the adhesion to PROTEIN LEATHER under wet conditions according to Test Method 8 and summarized in Table 7. These samples were also assessed for gel content in accordance with Test Method 1

TABLE 7
Average Peel Force to Wet PROTEIN
LEATHER of CE-1 and Examples 11-12

| | Adhesion (wet) | Gel Content |
|---|---|---|
| Example | g/in (N/dm) | % |
| CE-1 | 829 (31.9) | N.D. |
| 11 | 944 (36.4) | 23.00 ⁺/− 2.92 |
| 12 | 891 (34.3) | 30.68 ⁺/− 1.78 |

### Examples 13-15: Preparation and Analysis of Adhesive Compositions Containing Acidic and Basic Comonomers

For each Example, the general procedure for “Preparation of ‘100% Solids’ or ‘Bulk’ Polymers” was followed by using the amounts (in parts by weight based on the total weight of ISOMER MIX B, AA, and NVP) listed in Table 8 to provide three additional Examples (Exs. 13-15).

TABLE 8
Compositions of Examples 13-14

| RM | 13 | 14 |
|---|---|---|
| ISOMER MIX B | 97.5 | 97.5 |
| NVP | 2 | 2 |
| AA | 0.5 | 0.5 |
| Photoinitiator | 0.2 | 0.2 |
| IOTG | 0.1 | 0.1 |
| HDDA | 0 | 0.01 |
| Antioxidant 1 | 0.6 | 0.6 |
| ABP | 0.14 | 0.10 |

A sample of examples 12, 13, or 14 from each example was compounded in a single screw extruder at 150° C. for three minutes at 300 rpm. The resulting hotmelt was coated onto a silicone release liner using a drop die. The extrusion temperatures for the die and extruder were kept at 150° C. The extruded samples were coated at 3 mil (76 micrometers) thickness. A portion of the samples were then cured at 60 mJ/cm² of UV-C radiation using a UV fusion lamp and H-bulb. The samples were later hand laminated onto 0.0625 inch thick EVA foam obtained from Sekesui Voltek under the trade name EO Volaro using a 5 lb (2.2 kg) hand roller.

Examples 12-14 were tested by measuring the adhesion to PROTEIN LEATHER under dry and wet conditions according to Test Methods 7 and 8 and summarized in Table 9.

TABLE 9
Average Peel Force to Dry and Wet
PROTEIN LEATHER Examples 12-14.

| | Adhesion (dry) | Adhesion (wet) | Adhesive |
|---|---|---|---|
| Example | N/in (N/dm) | N/in (N/dm) | Shrinkage (%) |
| 12 | 2.64 (10.38) | 0.88 (3.46) | 47% |
| 13 | 1.74 (6.84) | 1.07 (4.21) | 6% |
| 14 | 2.23 (8.76) | 1.52 (5.97) | 15% |

### Examples 15-17: Preparation of Adhesive Compositions Containing a Tackifier

For each Example, the general procedure for “Preparation of ‘100% Solids’ or ‘Bulk’ Polymers” was followed by using the amounts (in parts by weight based on the total weight of ISOMER MIX B, AA, and NVP) listed in Table 8 to provide three additional Examples (Exs. 15-17).

A sample of adhesive was combined with 10 parts by weight of P125 tackifier and compounded in a twin screw extruder at 320° F. (160° C.) in a Dynamelt C feeder. The resulting hotmelt was processed at 248° F. (120° C.) coated onto a silicone release liner using a drop die. The extrusion temperatures for the die and extruder were kept at 320° F. The extruded samples were coated at the thickness indicated in Table 10. The samples were then cured at 55 mJ/cm² of UV-C radiation using a UV fusion lamp and H-bulb. The samples were then covered with 0.0625 inch thick EVA foam obtained from Sekesui Voltek under the trade name EO Volaro and wound into a roll.

TABLE 10
Compositions of Examples 15-17 containing
tackifier at different coat weights

| RM | 15 | 16 | 17 |
|---|---|---|---|
| ISOMER MIX B | 97.5 | 97.5 | 97.5 |
| NVP | 2 | 2 | 2 |
| AA | 0.5 | 0.5 | 0.5 |
| Photoinitiator | 0.2 | 0.2 | 0.2 |
| IOTG | 0.1 | 0.1 | 0.1 |
| HDDA | 0.01 | 0.01 | 0.01 |
| Antioxidant 2 | 0.3 | 0.3 | 0.3 |
| ABP | 0.10 | 0.10 | 0.10 |
| P125 | 10 | 10 | 10 |
| Coat Weight (mil) | 2.4 | 3.0 | 4.0 |

Examples 15-17 were tested by measuring the adhesion to PROTEIN LEATHER under dry and wet conditions according to Test Methods 7 and 8 and summarized in Table 11.

TABLE 11
Average Peel Force to Dry and Wet
PROTEIN LEATHER Examples 12-14.

| | Adhesion (dry) | Adhesion (wet) | Adhesive |
|---|---|---|---|
| Example | N/in (N/dm) | N/in (N/dm) | Shrinkage (%) |
| CE-1 | 2.52 (9.90) | 0.73 (2.86) | N.D. |
| 15 | 3.08 (12.10) | 1.81 (7.11) | <5% |
| 16 | 3.51 (13.79) | 2.14 (8.41) | <5% |
| 17 | 4.66 (18.31) | 2.63 (10.34) | <5% |

### Examples 18-19: Preparation of Adhesive Compositions Containing a Tackifier

For each Example, the general procedure for “Preparation of ‘100% Solids’ or ‘Bulk’ Polymers” was followed by using the amounts (in parts by weight based on the total weight of ISOMER MIX B, AA, and NVP) listed in Table 8 to provide three additional Examples (Exs. 18-19).

TABLE 12
Compositions of Examples 18-19 containing
tackifier at different coat weights

| RM | 18 | 19 |
|---|---|---|
| ISOMER MIX B | 97.5 | 97.5 |
| NVP | 2 | 2 |
| AA | 0.5 | 0.5 |
| Photoinitiator | 0.2 | 0.2 |
| IOTG | 0.1 | 0.1 |
| HDDA | 0.01 | 0.01 |
| Antioxidant 1 | 0.3 | 0.3 |
| ABP | 0.10 | 0.10 |
| P125 | 10 | 0 |
| P100 | 0 | 10 |

A sample of material from each example in Table 3 was compounded in a Bonnot Extruder from the Bonnot Company at 275° F. (135° C.) and screw speed of 30 rpm. The heated sample was pumped to a twin screw extruder at a temperature of 320° F. (160° C.) and screw speed of 200 rpm. The resulting hotmelt was coated onto a silicone release liner using a rod coater die. The extrusion temperatures for the die and extruder were kept at 320° F. (160° C.). The extruded sample was coated at 3 mil (76 micrometers) thickness. The samples were then immediately cured at 50 mJ/cm² of UV-C radiation using a UV fusion lamp and H-bulb. The samples were then covered with EVA foam and wound into a roll.

The roll of adhesive was converted to the electrode form factor using standard manufacturing practice used to prepare commercial electrodes.

TABLE 13
Average Pull Force to Wet PROTEIN
LEATHER of Examples 18-19.

| | Pull Force (wet) | Adhesive |
|---|---|---|
| Example | N/in (N/dm) | Shrinkage (%) |
| CE-1 | 1134 (4456) | N.D. |
| 18 | 1282 (5038) | <5% |
| 19 | 1358 (5337) | <5% |

### Example 12, Example 15, and Comparative Example 1: Physical Property Testing Via Rheology

Example 12 and Example 15 were compounded in a Bonnot Extruder from the Bonnot Company at 275° F. (135° C.) and screw speed of 30 rpm. The heated sample was pumped to a twin screw extruder at a temperature of 320° F. (160° C.) and screw speed of 200 rpm. The resulting hotmelt was coated onto a silicone release liner using a rod coater die. The extrusion temperatures for the die and extruder were kept at 320° F. (160° C.). The extruded sample was coated at 3 mil (76 micrometers) thickness. The samples were then optionally cured at 50 mJ/cm² of UV-C radiation using a UV fusion lamp and H-bulb. The samples were then assessed according to Test Method 2. Comparative Example 1 was taken from typical manufacturing conditions and assessed according to Test Method 2.

TABLE 14
Rheological characteristics of Examples 12, 15, and CE-1.

| | UVC | T_{g} | G′ at 25° C. | η at 25° C. |
|---|---|---|---|---|
| Example | Curing | (° C.) | (Pa) | (Pa-s) |
| CE-1 | None | −14 | 71520 | 13820 |
| 12 | None | −36 | 11250 | 2362 |
| 12 | Yes | −35 | 15390 | 3050 |
| 15 | Yes | −34 | 17370 | 3400 |

1. An adhesive article comprising:
a substrate with a first major surface and a second major surface; and
a hot melt processable pressure sensitive adhesive layer disposed on at least a portion of the first major surface of the substrate, the pressure sensitive adhesive layer comprising a (meth)acrylate-based polymer comprising the cured reaction product of a mixture comprising:
89.0-99.49% by weight of at least one first (meth)acrylate monomer;
0.5-5.0% by weight of a non-acid-functional, ethylenically unsaturated polar monomer;
an acid-functional ethylenically unsaturated monomer, wherein the acid-functional ethylenically unsaturated monomer is present in an amount of up to 1% by weight;
0.01-5% by weight of at least one crosslinking moiety; and
0.01-1.0 parts by weight of at least one initiator based upon the total weight of curable components,
wherein the first (meth)acrylate monomer comprises a secondary branched (meth)acrylate with a total of 10-17 carbon atoms or a mixture of secondary alkyl (meth)acrylate isomers with a total of 8-18 carbon atoms, and the adhesion of the adhesive article to a wet PROTEIN LEATHER surface is at least 50% of its adhesion to the same dry PROTEIN LEATHER surface.

2. The adhesive article of claim 1, wherein the first (meth)acrylate comprises a mixture of secondary alkyl (meth)acrylate isomers of Formula (I): 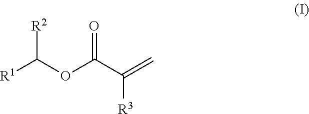
wherein:
R¹ and R² are each independently a C₁ to C₁₀ saturated linear alkyl group;
the sum of the number of carbons in R¹ and R² is 8 to 18; and
R³ is H or CH₃.

3. The adhesive article of claim 2, wherein the mixture of secondary alkyl (meth)acrylate isomers comprises a mixture at least 5 isomers.

4. The adhesive article of claim 2, wherein R¹ and R² are each independently a C₁ to C₁₀ saturated linear alkyl and the sum of the number of carbons in R¹ and R² is 9 to 17.

5. The adhesive article of claim 2, wherein R¹ and R² are each independently a C₁ to C₁₀ saturated linear alkyl and the sum of the number of carbons in R¹ and R² is 9 to 13.

6. The adhesive article of claim 1, wherein the crosslinking moiety comprises a photocrosslinker, a multi-functional (meth)acrylate, or a combination thereof.

7. The adhesive article of claim 1, wherein the non-acid-functional, ethylenically unsaturated polar monomer comprises NVP (N-vinyl pyrrolidone), NVC (N-vinylcaprolactam), acrylamide mono- or di-N-alkyl substituted acrylamide, t-butyl acrylamide, dimethylaminoethyl acrylamide or N-octyl acrylamide.

8. The adhesive article of claim 1, wherein the substrate comprises a polymeric film, a tape backing, or a medical device.

9. The adhesive article of claim 1, wherein the pressure sensitive adhesive layer further comprises at least 2 to 25 parts of at least one tackifier, relative to 100 parts of the (meth)acrylate-based polymer.

10. The adhesive article of claim 1, wherein the adhesive article has adhesion to a wet PROTEIN LEATHER surface of at least 1 Newton/25 millimeters.

11. The adhesive article of claim 1, wherein the pressure sensitive adhesive has a modulus of greater than 10,000 Pascals at 25° C. as measured by DMA.

12. The adhesive article of claim 1, wherein the pressure sensitive adhesive article has a shrinkage of less than 10% as measured by the Shrinkage Test.

13. An adhesive composition comprising:
a packaging material; and
a pressure sensitive adhesive, the pressure sensitive adhesive comprising a (meth)acrylate polymer comprising the cured reaction product of a mixture comprising:
89-99.49% by weight of at least one first (meth)acrylate monomer;
0.5-5.0% by weight of a non-acid-functional, ethylenically unsaturated polar monomer;
an acid-functional ethylenically unsaturated monomer, wherein the acid-functional ethylenically unsaturated monomer is present in an amount of up to 1% by weight;
0.01-5% by weight of a crosslinking moiety; and
0.01-1.0 parts by weight of at least one initiator based upon the total weight of curable components,
wherein the first (meth)acrylate monomer comprises a secondary branched (meth)acrylate with a total of 10-17 carbon atoms or a mixture of secondary alkyl (meth)acrylate isomers with a total of 8-18 carbon atoms, and the adhesion of the adhesive article to a wet PROTEIN LEATHER surface is at least 50% of its adhesion to the same dry PROTEIN LEATHER surface;
wherein the pressure sensitive adhesive is contained within the packaging material, and wherein the packaged pressure sensitive adhesive is hot melt processable.

14. The adhesive composition of claim 13, wherein the first (meth)acrylate comprises a mixture of secondary alkyl (meth)acrylate isomers of Formula (I): 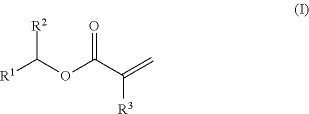
wherein:
R¹ and R² are each independently a C₁ to C₁₀ saturated linear alkyl group;
the sum of the number of carbons in R¹ and R² is 8 to 18; and
R³ is H or CH₃.

15. The adhesive composition of claim 14, wherein the mixture of secondary alkyl (meth)acrylate isomers comprises a mixture at least 5 isomers.

16. The adhesive composition of claim 14, wherein R¹ and R² are each independently a C₁ to C₉ saturated linear alkyl and the sum of the number of carbons in R¹ and R² is 9 to 17.

17. A method of forming an adhesive article comprising:
providing a substrate with a first major surface and a second major surface;
providing a packaged adhesive composition;
disposing the packaged adhesive composition in a hot melt mixing apparatus;
hot melt mixing the packaged adhesive composition;
dispensing the hot melt mixed adhesive composition onto at least a portion of the second major surface of the substrate surface to form a pressure sensitive adhesive layer;
wherein the packaged adhesive composition comprises a (meth)acrylate-based polymer comprising the cured reaction product of a mixture comprising:
89-99.49% by weight of at least one first (meth)acrylate monomer;
0.5-5.0% by weight of a non-acid-functional, ethylenically unsaturated polar monomer;
an acid-functional ethylenically unsaturated monomer, wherein the acid-functional ethylenically unsaturated monomer is present in an amount of up to 1% by weight;
0.01-2% by weight of a crosslinking moiety; and
0.01-1.0 parts by weight of at least one initiator based upon the total weight of curable components,
wherein the first (meth)acrylate monomer comprises a secondary branched (meth)acrylate with a total of 10-17 carbon atoms or a mixture of secondary alkyl (meth)acrylate isomers with a total of 8-18 carbon atoms; and
wherein the adhesion of the adhesive article to a wet PROTEIN LEATHER surface is at least 50% of its adhesion to the same dry PROTEIN LEATHER surface.

18. The method of claim 17, wherein disposing the packaged adhesive composition in a hot melt mixing apparatus further comprises adding a tackifier to the hot melt mixing apparatus.

19. The method of claim 17, wherein the substrate comprises a polymeric film, a tape backing, or a medical device.

20-21. (canceled)
